(19) United States
(12) Patent Application Publication
(10) Pub. No.: US 2019/0221850 A1
(43) Pub. Date: Jul. 18, 2019

(54) SLURRY CONTAINING DISPERSED ACETYLENE BLACK, AND LITHIUM-ION SECONDARY BATTERY

(71) Applicant: MIKUNI SHIKISO KABUSHIKI KAISHA, Himeji-shi (JP)

(72) Inventors: Kazuhiro Tachibana, Yonezawa-shi (JP); Taizou Haruyama, Himeji-shi (JP); Takuya Kitagawa, Himeji-shi (JP); Naoya Kawamura, Himeji-shi (JP); Yasuhiro Yamamoto, Himeji-shi (JP)

(73) Assignee: MIKUNI SHIKISO KABUSHIKI KAISHA, Himeji-shi (JP)

(21) Appl. No.: 16/363,577

(22) Filed: Mar. 25, 2019

Related U.S. Application Data
(62) Division of application No. 14/428,094, filed on Jul. 6, 2015.

(30) Foreign Application Priority Data
Sep. 14, 2012 (JP) 2012-202429

(51) Int. Cl. H01M 4/62; H01M 4/139; H01M 4/04; C09D 1/00; H01M 4/13

(52) U.S. Cl. CPC H01M 4/625; H01M 4/139; H01M 4/0404; H01M 10/052; H01M 4/04; H01M 4/13; H01M 4/622; C09D 1/00

(57) ABSTRACT

Provided is a production method of a coating composition for electrode, which is able to determine suitable conditions in a dispersion step of an electrode slurry for positive electrode for lithium ion battery, in terms of numerical values, and to enhance performances of the resulting battery. A production method of an electrode slurry for positive electrode for lithium ion secondary battery, including kneading at least a carbon material as an electroconductive material and a solvent into a dispersion, is disclosed. As for the carbon material-dispersed slurry, its alternating current impedance value immediately after the dispersion is controlled to a prescribed numerical value.

### CROSS-REFERENCE TO RELATED APPLICATIONS

The present application is a divisional of U.S. patent application Ser. No. 14/428,094, filed Jul. 6, 2015, which is a 371 of International Application No. PCT/JP2013/074953, filed Sep. 13, 2013, which is based upon and claims the benefits of priority to Japanese Application No. 2012-202429, filed Sep. 14, 2012. The entire contents of all of the above applications are incorporated herein by reference.

### TECHNICAL FIELD

The present invention relates to a carbon material-dispersed slurry, and in more detail, the present invention relates to a nonaqueous carbon material slurry for electrode slurry for lithium ion secondary battery positive electrode and a lithium ion secondary battery using the same.

### BACKGROUND ART

With the spread of mobile phones, notebook type personal computers, and the like, lithium ion secondary batteries are attracting interest, and a demand therefor is increasing. In current lithium ion secondary batteries, for the purpose of increasing efficiency of a battery reaction by making an electrode area large, positive and negative electrodes in which a coating material having an electrode active material mixed with a binder, an electroconductive material, and the like is applied onto a strip-shaped metal foil are used, and these are wound together with a separator and then accommodated in a battery can (PTL 1, etc.).

Among these, the positive electrode uses a lithium transition metal complex oxide or the like as the electrode active material. When such an electrode active material is used alone, its electron conductivity, namely electroconductivity is poor. Therefore, in order to give electroconductivity, a carbon material, such as electroconductive carbon black with a highly developed structure, graphite in which a crystal thereof exhibits remarkable anisotropy, etc., is added as an electroconductive material, which is dispersed in a nonaqueous solvent, such as N-methyl-2-pyrrolidone, etc., together with a binder (binding material), thereby preparing a slurry (PTL 2); and this slurry is applied onto a metal foil and then dried, thereby forming a positive electrode.

However, existent lithium ion secondary batteries are required to be more enhanced in electrode performances, such as discharge capacity, etc. The carbon black or graphite that is a carbon material to be used as the electroconductive material is a fine powder having a small primary particle diameter and is a material in which aggregation is strong, so that it is very difficult to uniformly disperse it. In addition, the electrode active material is a powder, too. Thus, it was pointed out that on the occasion of mixing these materials, so long as the aggregation of the carbon material is not loosened, a portion with inferior electroconductivity exists locally within the positive electrode, and the movement of electrons is not thoroughly conducted, and therefore, the electrode active material is not effectively utilized, and as a result, a low discharge capacity is caused (PTL 1, etc.).

Then, there have been proposed a method in which a surface of an electrode active material is coated with a carbon material (PTL 1); and a method in which carbon black as a carbon material is previously dispersed in a dispersion medium, such as an organic solvent, etc., together with a dispersant, to form a slurry, which is then kneaded together with an active material and a binder to form an electrode, thereby preparing a uniform electrode slurry (PTL 5, PTL 6, PTL 7, PTL 8, PTL 9, PTL 10, PTL 11, and PTL 12).

In addition, it was pointed out that there is such a problem that aggregates of a powder of an electrode active material and a powder of a carbon material are not completely loosened, thereby generating a surface fault on a positive electrode surface, such as streaks or projections to be caused due to the aggregates, etc.; and that even if it is attempted to remove the aggregates by means of filtration, plugging occurs within a short period of time, so that in order to remove the aggregates, a very long period of time of kneading is required, thereby causing an increase of costs (PTL 3). Then, there has been proposed a method in which a solvent and a binding material are subjected to mixing and dissolution or dispersion in advance, and thereafter, an electrode active material and an electroconductive material are additionally kneaded therewith (PTL 3).

In addition, based on a relationship between physical properties of a coating liquid containing an electrode active material and an electroconductive material and battery performances, it has been that a viscosity of each of coating liquids for forming plural layers constituting an electrode of a lithium ion secondary battery, namely an electrode layer containing an electrode active material, a primer layer, and a polymer electrolyte layer, is regulated such that when a shear rate of 2×10² s⁻¹ is given, a dynamic viscosity coefficient is 1×10⁻³ to 5×10² Pa·s, and a difference in viscosity of coating material between the layers adjacent to each other is 1×10² Pa·s or less in comparison of the dynamic viscosity coefficient at the above-described shear rate (PTL 4). It has been argued that the boundary surface adhesion or adhesiveness between these plural layers influences the variability in internal impedance in a battery and battery performances related to the charge and discharge, and by regulating the dynamic viscosity coefficient as described above, the battery performances are enhanced.

### CITATION LIST

### Patent Literature

PTL 1: JP-A-2003-308845

PTL 2: JP-A-2003-157846

PTL 3: JP-A-H11-144714

PTL 4: JP-A-H11-185733

PTL 5: JP-A-2011-70908

PTL 6: JP-A-2011-113821

PTL 7: Japanese Patent No. 4235788

PTL 8: JP-A-2010-238575

PTL 9: JP-A-2011-192020

PTL 10: JP-A-2007-335175

PTL 11: JP-A-2004-281096

PTL 12: JP-A-2009-252683

### SUMMARY OF INVENTION

### Technical Problem

However, even by adopting these methods, the level or uniformity of the battery performances was not sufficient. Even by adopting the above-described method of dispersing a carbon material and an electrode active material in advance, it may be presumed that the uniformity of a dispersed state at micro levels as the battery material is not sufficient. As a reason thereof, a cause-and-effect relationship between slurry physical properties and resulting battery performances is not sufficiently elucidated, and therefore, the physical properties of slurry as indexes of the performances on the occasion of forming an electrode are not ascertained yet. For this reason, according to observation of the particle state or measurement of rheological physical properties as general evaluation means of the slurry, the battery performances cannot be controlled. Though there is knowledge based on a relationship between rheological characteristics and the variability in battery performances, such as internal impedance, etc., as described in the above-cited PTL 4, a dynamic viscosity coefficient within the foregoing range does not necessarily guarantee sufficient battery performances and is not sufficient as an evaluation means, too.

In view of the foregoing problems of the conventional technologies, the present invention has been made. An object thereof is to provide a carbon material-dispersed slurry capable of exhibiting excellent battery performances and a production method of a carbon material-dispersed slurry for lithium ion secondary battery, which is able to determine suitable conditions for a dispersion step of the carbon material in terms of numerical values and to enhance performances of the resulting battery.

### Solution to Problem

In order to achieve the foregoing object, the present inventors made extensive and intensive investigations, paid attention to the alternating current impedance method, and then conducted an alternating current impedance measurement of a carbon material slurry. As a result, it has been found that when its admittance value is set within a prescribed range, performances of the resulting lithium ion secondary battery are enhanced, leading to accomplishment of the present invention.

Specifically, the present invention is concerned with (1) an acetylene black-dispersed slurry that is a slurry containing at least acetylene black and a dispersion medium, wherein a content of acetylene black in the slurry is 10% by mass or more and 30% by mass or less, and a viscosity measured by a B-type viscometer is 100 mPa·s or more and 5,000 mPa·s or less; (2) an acetylene black-dispersed slurry that is a slurry containing at least acetylene black and a dispersion medium, wherein a content of acetylene black in the slurry is 10% by mass or more and 30% by mass or less, and a shear rate at which the viscosity becomes a minimum value is 100 to 1,000 s⁻¹; (3) an acetylene black-containing slurry that is a slurry containing at least acetylene black and a dispersion medium, wherein a content of acetylene black in the slurry is 10% by mass or more and 30% by mass or less, a concentration dependence of admittance at an impressed frequency of 1,000 Hz, as obtained by the alternating current impedance measurement, is 1.0 S/mass % or less, and a phase difference is in the range of from 50 to 200; (4) the acetylene black-containing slurry as set forth above in any one of (1) to (3), wherein N-methyl-2-pyrrolidone is contained as the dispersion medium; (5) the acetylene black-containing slurry as set forth above in any one of (1) to (4), further containing a dispersibility imparting agent; (6) the acetylene black-containing slurry as set forth above in (5), wherein the dispersibility imparting agent is a nonionic polymer resin; (7) the acetylene black-containing slurry as set forth above in (6), wherein the nonionic polymer resin is a cellulose-type polymer or a butyral-type polymer; (8) the acetylene black-containing slurry as set forth above in (6) or (7), wherein the nonionic polymer resin has a weight average molecular weight of 1,000 to 1,000,000; (9) the acetylene black-containing slurry as set forth above in (8), wherein the nonionic polymer resin has a weight average molecular weight of 5,000 to 300,000; (10) a production method of a positive electrode of lithium ion secondary battery, comprising mixing the acetylene black-containing slurry as set forth in any one of (1) to (9) with at least an electrode active material and a binder to coat an electrode substrate therewith, followed by drying;

(11) a lithium ion secondary battery comprising a positive electrode of lithium ion secondary battery obtained by the production method as set forth above in (10); (12) a production method of an acetylene black-dispersed slurry that is a slurry containing at least acetylene black and a dispersion medium and having a content of acetylene black of 10% by mass or more and 30% by mass or less, the method comprising controlling any one of (i) a shear rate at which a viscosity becomes a minimum value, (ii) a viscosity measured by a B-type viscometer, and (iii) a concentration dependence of admittance and a phase difference obtained from the alternating current impedance measurement; (13) the production method of a slurry containing at least acetylene black and a dispersion medium as set forth above in (12), wherein a dispersion step is conducted until the viscosity measured by a B-type viscometer reaches 100 mPa·s or more and 5,000 mPa·s or less; (14) the production method of a slurry containing at least acetylene black and a dispersion medium as set forth above in (12), wherein a dispersion step is conducted until the shear rate at which the viscosity becomes a minimum value reaches 100 to 1,000 s⁻¹; (15) the production method of a slurry containing at least acetylene black and a dispersion medium as set forth above in (12), wherein a dispersion step is conducted until the concentration dependence of admittance reaches 1.0 μS/mass % or less, and the phase difference reaches 50 or more and 200 or less, at an impressed frequency of 1,000 Hz, as obtained by the alternating current impedance measurement; (16) a production method of a positive electrode of lithium ion secondary battery, comprising mixing a slurry obtained by the production method of a slurry as set forth in any one of (12) to (15) with at least an electrode active material and a binder to coat an electrode substrate therewith, followed by drying; and (17) a lithium ion secondary battery comprising a positive electrode of lithium ion secondary battery as obtained by the production method as set forth above in (17).

### Advantageous Effects of Invention

According to the present invention, on the occasion of dispersing a carbon material that is an electroconductive material in a dispersion medium in advance, an admittance value or the like can be set within a prescribed range, whereby suitable conditions for the dispersion step of the carbon material can be determined in terms of numerical values, the control of the production step can be largely enhanced, and performances of the resulting battery can also be enhanced.

### BRIEF DESCRIPTION OF DRAWINGS

FIG. 1 is a graph showing a relationship between a change in carbon concentration in a slurry and a change in phase difference.

FIG. 2 is a graph showing a relationship between a change in carbon concentration in a slurry and an equivalent admittance.

FIG. 3 is a view showing dimensions of an aluminum foil flag type electrode.

FIG. 4 is a view showing a cell for measuring a phase difference and an admittance.

### DESCRIPTION OF EMBODIMENTS

The present invention is hereunder specifically described.

### [Carbon Material Species]

In the present invention, acetylene black is used as the carbon material. As for the acetylene black, crystallites and structures are highly developed, and its electroconductivity is excellent. Thus, the acetylene black is suitable as an electroconductive material of lithium ion battery. Furthermore, when the acetylene black is formed into a slurry having prescribed physical properties of the present invention as described below, its concentration in the slurry may be increased, and an amount of a solvent, such as N-methyl-2-pyrrolidone, etc., in the electrode slurry to coat an electrode substrate may be decreased. Thus, simplification of a drying step may be achieved, and a cost reduction due to a decrease of transportation amount at the time of transportation may be expected, and hence, the acetylene black is suitable.

### [Dispersibility Imparting Agent]

The slurry of the present invention may contain a dispersibility imparting agent. The dispersibility imparting agent as referred to herein means a material having a function to make it easy to disperse the acetylene black in a dispersion medium, and materials which have hitherto been known as a so-called dispersant may be used. For example, as described in PTL 8, there are exemplified resin-based or cationic surfactants and nonionic surfactants, each having a thickening action and/or a surface active action, or the like. Among these dispersibility imparting agents, preferably, nonionic polymer resins that do not inhibit the movement of a lithium ion within a lithium ion secondary battery are suitable in the present invention. The nonionic polymer resin as referred to herein is a material having a hydrophilic portion in which a hydrophilic segment thereof is not ionized, and representative examples thereof include cellulose-type polymers and butyral-type polymers. In addition, as for the nonionic polymer resin, if its weight average molecular weight is more than 1,000,000, a viscosity of the carbon material-dispersed slurry becomes excessively high, so that handling properties are deteriorated. Meanwhile, if the weight average molecular weight is less than 1,000, dispersibility is poor, so that the production of the carbon material-dispersed slurry becomes difficult. The weight average molecular weight is more preferably 5,000 to 300,000.

### [Acetylene Black-Dispersed Slurry]

The slurry of the present invention is obtained by using acetylene black. It is to be noted that the slurry as referred to herein means one in a state where the acetylene black is dispersed in a liquid dispersion medium. The dispersion medium is suitably N-methyl-2-pyrrolidone. If a content of the dispersion medium is less than 60% by mass of the slurry, fluidity is poor, so that handling properties are lowered. The content of the dispersion medium is at least 60% by mass or more, and preferably 70% by mass or more.

### [Concentration]

A content of the acetylene black in the slurry is 10% by mass or more and 30% by mass or less, and preferably 15% by mass or more and 25% by mass or less. If the content of the acetylene black is less than 10% by mass, the amount of the solvent in the slurry increases, and hence, it takes a time for the drying step in the coating step. In addition, it is to be noted that if the content of the acetylene black is more than 30% by mass, dispersion of the acetylene black tends to become difficult.

### [Relationship Among Respective Physical Properties of Slurry]

As described above, the acetylene black-dispersed slurry of the present invention contains acetylene black within a specified concentration range. Furthermore, respective physical properties inclusive of a viscosity, a shear rate at which the viscosity becomes a minimum value, a concentration dependence of admittance, and a phase difference are regulated so as to fall within specified ranges. It has been found by the present inventors that these reflect the dispersed state of the acetylene black in the slurry and are mutually related to each other. Then, it has been found that the acetylene black-dispersed slurry having a combination of the following physical properties can exhibit excellent performances on the occasion of fabricating a battery. First of all, a first embodiment is concerned with an acetylene black-dispersed slurry in which the concentration and the viscosity are regulated so as to fall within specified ranges. Next, a second embodiment is concerned with an acetylene black-dispersed slurry in which the concentration and the shear rate at which the viscosity becomes a minimum value are regulated so as to fall within specified ranges. Furthermore, a third embodiment is concerned with an acetylene black-dispersed slurry in which the concentration, the concentration dependence of admittance, and the phase difference are regulated so as to fall within specified ranges. The respective physical properties are hereunder described.

### [Viscosity]

The slurry of the present invention has a viscosity, as measured by a B-type viscometer, of 100 mPa·s or more and 5,000 mPa·s or less, and preferably 100 mPa·s or more and 3,000 mPa·s or less. It has been found that by regulating the dispersed state within the above-described concentration range so as to allow the viscosity to fall within the foregoing range, excellent performances are revealed on the occasion of fabricating a battery. In addition, in the case where the viscosity is lower than the foregoing range, the viscosity of an electrode paste to coat an electrode plate becomes excessively low, so that a problem that the coating workability becomes difficult is generated.

[Shear Rate at which the Viscosity Becomes a Minimum Value]

By regulating the shear rate at which the viscosity becomes a minimum value to the range of from 100 to 1,000 s⁻¹, the acetylene black-dispersed slurry having excellent performances according to the present invention may be obtained. In general, for dispersed slurries, it is frequently aimed to obtain a Newtonian fluid. But, the present inventors have thought that in order to control electroconductivity, the carbon material-dispersed slurry for lithium ion secondary battery is preferably a dilatant fluid that keeps the state where the carbon materials are connected with each other to some extent in the dispersion liquid. This is because it may be presumed that if the slurry is a Newton fluid, the carbon materials are excessively sufficiently dispersed, so that connection of the carbon materials with each other is poor, and the electroconductivity is poor. For that reason, the present inventors have presumed that it is necessary to achieve the dispersion to an extent that a maximum particle diameter is 20 μm or less, while leaving some connection of the carbon materials with each other. Then, the present inventors made extensive and intensive investigations regarding rheological characteristics of the slurry. As a result, it has been found that a slurry in which a shear rate at which the viscosity becomes a minimum value exists within the range of from 100 to 1,000 s⁻¹ is excellent in electrical characteristics.

### [Dispersed Particle Diameter]

A dispersed particle diameter of the acetylene black in the slurry is preferably 20 μm or less in terms of a maximum particle diameter. In general, for controlling the particle state of a dispersion of a carbon material or the like, an average particle diameter is frequently adopted. However, on the occasion of adopting the average particle diameter, the state of coarse particles is not reflected, and even in the case where the average particle diameter is small, when coarse particles of 20 μm or more exist, exceeding the thickness between separators of lithium ion battery of 20 μm, there may be a possibility that the particles break through the separator, thereby causing a short circuit in the inside of the lithium ion secondary battery. Accordingly, a carbon material slurry having a maximum particle diameter of 20 m or less is preferred. It is to be noted that the maximum particle diameter is specified through measurement with a grind gauge. In order to keep the particle diameter at 20 μm or less in terms of a maximum particle diameter, it is extremely suitable to use the above-described nonionic polymer resin as the dispersibility imparting agent.

### [Concentration Dependence of Admittance]

In the acetylene black-dispersed slurry of the present invention, its concentration dependence of admittance is 1.0 μS/mass % or less, and preferably 0.9 μS/mass % or less. As for performances of the carbon material-dispersed slurry, in order that the carbon material-dispersed slurry may exhibit uniform electroconductivity within a lithium ion secondary battery positive electrode, it may be considered to be suitable that a change in admittance relative to a change in carbon material concentration is small. According to investigations made by the present inventors, it has become clear that if the concentration dependence of admittance is 1.0 μS/mass % or less, and especially preferably 0.9 μS/mass % or less, uniform electroconductivity may be exhibited. It has become clear that there is correlation between the concentration dependence of admittance and the dispersed state of carbon material, and in order to obtain the concentration dependence of admittance falling within the above-described suitable range, the dispersed state must be controlled. That is, if the dispersion is not sufficient, the battery performances are not sufficient. It may be presumed that this is caused due to the presence of coarse particles. On the other hand, surprisingly, it has become clear that if the particles are excessively dispersed, the battery performances are also inhibited. Though a reason thereof is not completely elucidated yet, the present inventors presume that this is caused due to a decrease of the connection of the acetylene blacks as the electroconductive material with each other.

### [Phase Difference]

In the slurry of the present invention, its phase difference obtained by the alternating current impedance measurement is 5° or more, and especially preferably 5° or more and 20° or less. On the occasion of fabricating a battery within the foregoing range, the particle state of the electroconductive material becomes a state suited for the lithium ion battery. It is to be noted that though the phase difference represents a capacitance of the carbon material, it may be presumed that the phase difference reflects the particle state in the dispersion liquid. If the dispersion is excessively made, the carbon material will exist in a very fine form in the liquid, so that it may be considered that the phase difference becomes very small, namely the capacitance becomes very small, whereby its suitability as a material of the lithium ion battery is lowered. In consequence, according to the investigations made by the present inventors, it has become clear that in preparing the carbon material slurry for battery, a slurry suitable as the battery material may be obtained by controlling the phase difference to the foregoing range. Conversely, it may be considered that if the phase difference is excessively large, the dispersion is not sufficient.

Similar to the present invention, in PTL 5 and PTL 7 that describe a slurry using a carbon material, such as acetylene black, etc., a nonionic polymer resin, and N-methyl-2-pyrrolidone as a dispersion medium, a compounding formulation and a dispersing method are described. However, so long as only the conditions described therein are followed, the control of physical properties is not sufficient, and the battery performances may not be predicted, so that the battery performances can not be grasped before a lithium ion battery is assembled. On the other hand, if the various physical properties in a state of the dispersion as specified in the present invention are measured, the battery performances can be predicted, whereby the dispersed state may be controlled. That is, by conducting the dispersion within the foregoing concentration range so as to allow the shear rate at which the viscosity becomes a minimum value to fall within the foregoing range, the viscosity may be allowed to fall within the foregoing range. In addition, the concentration dependence of admittance and the phase difference may also be allowed to fall within the foregoing ranges, respectively. Then, it may be considered that if the concentration dependence of admittance and the phase difference fall within the foregoing ranges, respectively, on the occasion of fabricating a battery, the electrical characteristics are excellent.

### [Slurry Preparation Method]

As for the acetylene black-dispersed slurry of the present invention, so long as the content of acetylene black, the viscosity measured by a B-type viscometer, the shear rate at which the viscosity becomes a minimum value, the concentration dependence of admittance, and the phase difference fall within the foregoing ranges, respectively, a production method thereof is not limited, but the following method is preferred. First of all, the acetylene black is dispersed in a dispersion medium. On that occasion, the above-described dispersibility imparting agent is added. Although it may be allowed to add another component that does not inhibit the functions, at least prior to adding an electrode active material and a binder, the dispersion should be in a state having prescribed physical properties as specified in the present invention by the following method.

That is, on the occasion of dispersing the acetylene black in the dispersion medium, the dispersion is conducted while controlling the shear rate at which the viscosity becomes a minimum value. More preferably, a nonionic polymer resin that is the dispersibility imparting agent is first dissolved in N-methyl-2-pyrrolidone that is the dispersion medium. The solution is mixed with acetylene black, and thereafter, the aggregated acetylene black is dispersed while crushing by a dispersion apparatus, such as a bead mill, etc., and the dispersion is continued until it reaches a prescribed shear rate at which the viscosity becomes a minimum value. In this way, an acetylene black-containing slurry having prescribed dispersed particle diameter, viscosity, concentration dependence of admittance at an impressed frequency of 1,000 Hz as obtained by the alternating current impedance measurement, and phase difference in a prescribed concentration may be obtained. A time to reach these physical properties is affected by a charge amount or an apparatus. Thus, in order to control these physical properties, it can be sufficient that the materials are mixed and dispersed in the above-described apparatus, a fixed amount of the dispersion is taken out and measured for the above-described respective physical properties, a time until the measured physical properties fall within the prescribed ranges is established, and from the next time, the dispersion is continued up to that time. However, as described above, there is correlation among the respective physical properties, and therefore, all of the physical properties may not have to be measured. As the dispersion apparatus, an apparatus capable of executing the dispersion such that the maximum particle diameter is 20 μm or less is preferred. However, the dispersion apparatus is not particularly limited to a bead mill, and examples thereof include a ball mill, a jet mill, and the like. It is to be noted that during the dispersion step, after measuring the viscosity to be measured by a B-type viscometer, the concentration dependence of admittance, and the phase difference obtained by the alternating impedance measurement, these physical properties may also be adopted directly as indexes for obtaining a desired dispersed state.

### [Lithium Ion Secondary Battery]

The acetylene black-dispersed slurry of the present invention as described above is used and mixed with an electrode active material, a binder, and the like to prepare an electrode slurry for coating an electrode substrate, whereby a lithium ion secondary battery may be obtained. As a method on that occasion, various methods which have hitherto been known may be adopted. Typically, the acetylene black-dispersed slurry of the present invention is mixed with an electrode active material and a binder to form a slurry, to coat an electrode substrate, followed by drying to form an electrode. This is used as a positive electrode of lithium ion secondary battery, a porous insulating material (separator) is interposed between the positive electrode and a negative electrode made of a carbon material, such as graphite, etc., the resultant is wound in a cylindrical or flat form depending upon the shape of a container, and an electrolyte solution is then injected thereinto.

The thus obtained lithium ion secondary battery of the present invention is able to enhance a discharge capacity retention rate at the time of repeated charge and discharge.

### Example 1

### [Production 1 of Acetylene Black-Dispersed Slurry]

1% by mass of a methyl cellulose polymer as a dispersibility imparting agent was dissolved in 79% by mass of N-methyl-2-pyrrolidone. The resulting solution was mixed with 20% by mass of “Denka Black Granule” (manufactured by Denki Kagaku Kogyo Kabushiki Kaisha) as acetylene black, and the aggregated acetylene black was dispersed using a bead mill while crushing. A sample was taken out, and a shear rate at which the viscosity becomes a minimum value was measured and found to be 170 s⁻¹. Thus, the shear rate was confirmed to exceed 100 s⁻¹, and the dispersion step was completed. The resulting acetylene black-dispersed slurry is designated as “Slurry 1”. Slurry 1 had a maximum particle diameter of 17.5 μm and a viscosity of 150 mPa·s and falls within the range where the maximum particle diameter is 20 μm or less, the viscosity is 100 mPa·s or more, the concentration dependence of admittance at an impressed frequency of 1,000 Hz is 1.0 μS/mass % or less, and the phase difference is 50 or more.

### Example 2

### [Production 2 of Acetylene Black-Dispersed Slurry]

The same operations as those in Example 1 were conducted, except that the dispersion was continued until the shear rate at which the viscosity becomes a minimum value reached 900 s⁻¹. The resulting acetylene black-dispersed slurry is designated as “Slurry 2”. Slurry 2 had a maximum particle diameter of 12.5 μm and a viscosity of 110 mPa·s.

### Example 3

### [Production 3 of Acetylene Black-Dispersed Slurry]

The same operations as those in Example 1 were conducted, except that butyral was used as the dispersibility imparting agent in place of the methyl cellulosed, and that the dispersion was continued until the shear rate at which the viscosity becomes a minimum value reached 110 s⁻¹. The resulting acetylene black-dispersed slurry is designated as “Slurry 3”. Slurry 3 had a maximum particle diameter of 17.5 μm and a viscosity of 900 mPa·s.

### Example 4

### [Production 4 of Acetylene Black-Dispersed Slurry]

The same operations as those in Example 1 were conducted, except that the dispersion was continued until the shear rate at which the viscosity becomes a minimum value reached 700 s⁻¹. The resulting acetylene black-dispersed slurry is designated as “Slurry 4”. Slurry 4 had a maximum particle diameter of 12.5 μm and a viscosity of 480 mPa·s.

### Comparative Example 1

### [Production 5 of Acetylene Black-Dispersed Slurry]

1% by mass of polyvinylpyrrolidone as a dispersibility imparting agent was dissolved in 79% by mass of N-methyl-2-pyrrolidone. The resulting solution was mixed with 20% by mass of acetylene black “Denka Black Granule” (manufactured by Denki Kagaku Kogyo Kabushiki Kaisha), and the aggregated acetylene black was dispersed using a bead mill while crushing. A sample was taken out, and a shear rate at which the viscosity becomes a minimum value was measured in the same manner as that in Example 1. Even after the shear rate at which the viscosity becomes a minimum value exceeded 1,000 s⁻¹, the dispersion was continued, and a sample was further taken out and measured. As a result, the shear rate at which the viscosity becomes a minimum value did not exist. This is designated as “Slurry 5”. Slurry 5 had a maximum particle diameter of 10.0 m and a viscosity of 15 mPa·s.

### Comparative Example 2

### [Production 6 of Acetylene Black-Dispersed Slurry]

1% by mass of a methyl cellulose polymer as a dispersibility imparting agent was dissolved in 85.5% by mass of N-methyl-2-pyrrolidone. The resulting solution was mixed with 13.5% by mass of acetylene black “FX-35” (manufactured by Denki Kagaku Kogyo Kabushiki Kaisha), and the aggregated acetylene black was dispersed using a bead mill while crushing. A sample was taken out, and a shear rate at which the viscosity becomes a minimum value was measured in the same manner as that in Example 1. Then, the dispersion was continued in the same manner as that in Comparative Example 1 until the shear rate at which the viscosity becomes a minimum value did not exist. The resulting acetylene black-dispersed slurry is designated as “Slurry 6”. Slurry 6 had a maximum particle diameter of 20.0 μm and a viscosity of 450 mPa·s.

### Comparative Example 3

### [Production 7 of Carbon Material-Dispersed Slurry]

2 parts by weight of a methyl cellulose polymer as a dispersibility imparting agent was dissolved in 88.0% by mass of N-methyl-2-pyrrolidone. The resulting solution was mixed with 10.0% by mass of ketjen black “EC300” (manufactured by Ketjenblack International Co., Ltd.), and the aggregated ketjen black was dispersed using a bead mill while crushing. A sample was taken out, and a shear rate at which the viscosity becomes a minimum value was measured in the same manner as that in Example 1. Then, the dispersion was continued in the same manner as that in Comparative Example 1 until the shear rate at which the viscosity becomes a minimum value did not exist. The resulting carbon material slurry is designated as “Slurry 7”. Slurry 7 had a maximum particle diameter of 17.5 μm and a viscosity of 400 mPa·s.

### Comparative Example 4

### [Production 8 of Acetylene Black-Dispersed Slurry]

The same operations as those in Example 1 were followed, except that the dispersion was stopped when the shear rate at which the viscosity becomes a minimum value was 10 s⁻¹. The resulting acetylene black-dispersed slurry is designated as “Slurry 8”. Slurry 8 had a maximum particle diameter of 30 μm and a viscosity of 280 mPa·s.

### Comparative Example 5

### [Production 9 of Acetylene Black-Dispersed Slurry]

The same operations as those in Example 1 were followed, except that the dispersion was continued in the same formulation as that in Example 1 in the same manner as that in Comparative Example 1 until the shear rate at which the viscosity becomes a minimum value did not exist. The resulting acetylene black-dispersed slurry is designated as “Slurry 9”. Slurry 9 had a maximum particle diameter of 12.5 μm and a viscosity of 70 mPa·s.

Various physical properties of Slurries 1 to 9 are shown in Table 1. The evaluation methods of these physical properties are as follows.

### [Measurement of Viscosity]

The viscosity was measured using a B-type viscometer in conformity with JIS K7117-1.

[Measurement of Shear Rate at which the Viscosity Becomes a Minimum Value]

The shear rate at which the viscosity becomes a minimum value was measured using a rheometer: MARSIII (manufactured by Thermo Fisher Scientific K.K.) and a sensor: DC60/2.

### [Measurement of Maximum Particle Diameter]

The maximum particle diameter was measured using a grind gauge in conformity with JIS K5600-2-5: 1999.

TABLE 1

| | | | | Shear rate |
|---|---|---|---|---|
| | | | | at which the |
| | | | Maximum | viscosity |
| | Carbon material | | particle | becomes a |
| | concentration | Viscosity | diameter | minimum value |
| | [%] | [mPa · s] | [μm] | [s⁻¹] |
| Example 1 | 20.0 | 150 | 17.5 | 170 |
| Example 2 | 20.0 | 110 | 12.5 | 900 |
| Example 3 | 20.0 | 900 | 17.5 | 110 |
| Example 4 | 20.0 | 480 | 12.5 | 700 |
| Comparative | 20.0 | 15 | 10.0 | No Existence |
| Example 1 | | | | |
| Comparative | 13.5 | 450 | 20.0 | No Existence |
| Example 2 | | | | |
| Comparative | 10.0 | 400 | 17.5 | No Existence |
| Example 3 | | | | |
| Comparative | 20.0 | 280 | 30.0 | 10 |
| Example 4 | | | | |
| Comparative | 20.0 | 70 | 12.5 | No Existence |
| Example 5 | | | | |

The evaluation methods of performances of the slurry are described.

### [Measurement of Admittance]

A 2-fold diluted carbon material-dispersed slurry and a 4-fold diluted carbon material-dispersed slurry were prepared, respectively by diluting each of Slurries 1 to 5 with N-methyl-2-pyrrolidone. Using these 2-fold diluted carbon material-dispersed slurry and 4-fold diluted carbon material-dispersed slurry, these diluted slurries were measured for phase difference and admittance at an impressed frequency of 1,000 Hz by the alternating current impedance method.

### [Explanation of Cell for Measuring Phase Difference and Admittance]

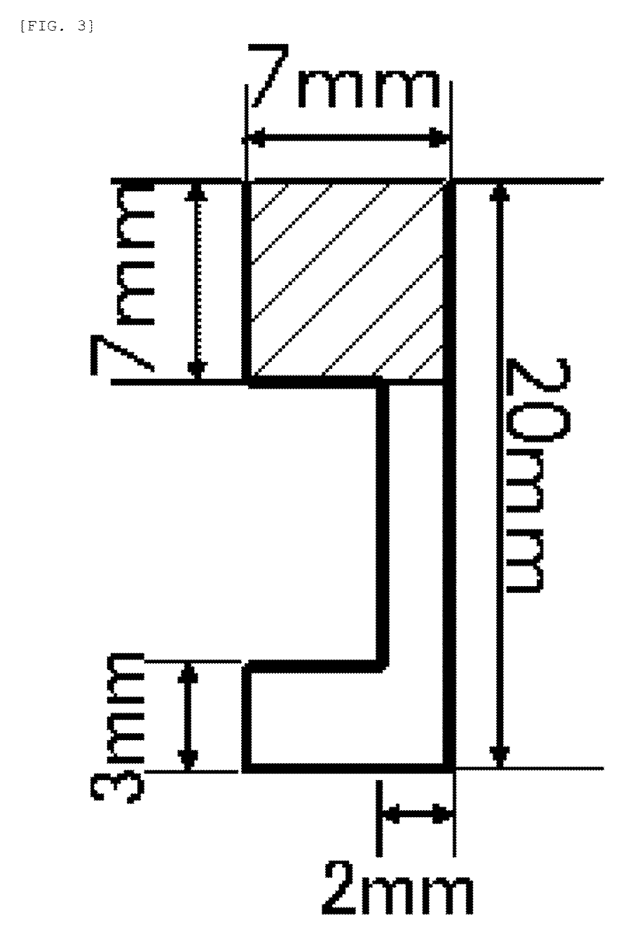

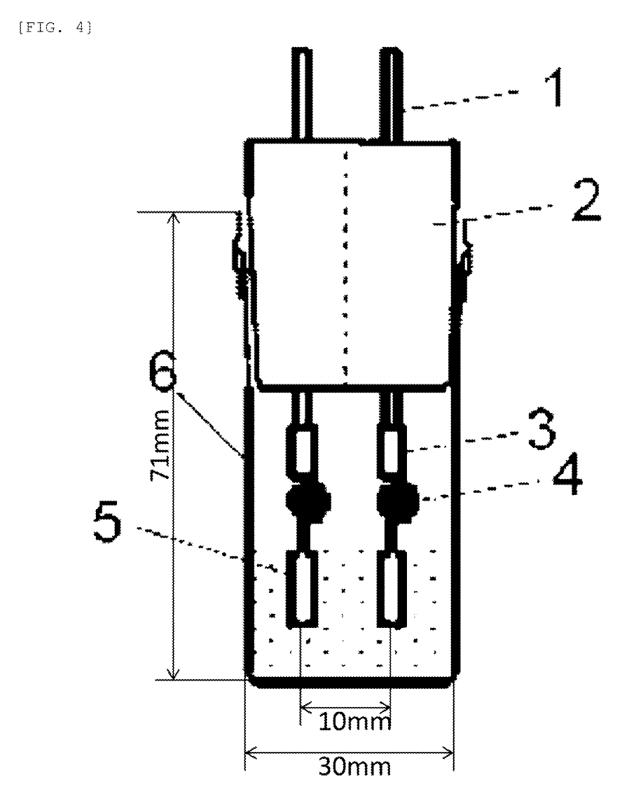

An aluminum foil having a purity of 99.99% and a thickness of 0.1 mm was cut out such that an electrode portion (shaded portion) had an area of 7 mm×7 mm, thereby fabricating two aluminum foil flag-type electrodes (FIG. 3). Two pieces prepared by installing a solderless terminal 3 (round terminal (R type), 1.25-3.7, manufactured by JST Co., Ltd.) in a tip of a stainless steel lead wire 1 (SUS304, ϕ1.5 mm, manufactured by The Nilaco Corporation) were fabricated, and the above-described aluminum foil was fixed to the solderless terminal portion with screw (iron tapping screw M3×5 mm) and nut 4 (for iron nut M3), thereby preparing measuring electrodes 5. At this time, a distance between the above-described aluminum foil flag type electrodes was set to 10 mm. Furthermore, a Teflon (registered trademark) cap 2 (#10, upper diameter: 32 mm, lower diameter: 28 mm, height: 41 mm, manufactured by SK Co., Ltd.) was provided with holes, through which the measuring electrodes 5 were then allowed to penetrate, followed by fixing. The slurry was weighed in a tall beaker 6 (IWAKI GLASS CODE 7740, manufactured by Sansyo Co., Ltd.), and a two-electrode cell was assembled such that an electrode portion of Al|slurry|Al was dipped in the slurry (FIG. 4).

### [Alternating Current Impedance Method]

The phase difference and the admittance were measured using a potentiostat (2020, manufactured by Toho Technical Research Co., Ltd.), a function generator (WF1945B, manufactured by NF Corporation), a lock-in amplifier (LI575, manufactured by NF Corporation), a recorder (GL900, manufactured by Graphtec Corporation), and an oscilloscope (2247A, manufactured by Tektronix, Inc.).

### [Measurement Method of Phase Difference]

The phase difference measured by the above-described alternating current impedance method is adopted as a phase difference of the slurry.

### [Calculation Method of Admittance]

Phase difference, voltage amplitude, current range, frequency, effective value, maximum sensitivity of the lock-in amplifier, and sensitivity are read out from the respective measurement instruments by the above-described alternating current impedance method, and a cell constant and an admittance are calculated according to calculation equations shown in the following Table 2.

TABLE 2

| Name | Symbol | Unit |
|---|---|---|
| Frequency | f | [Hz] = [S⁻¹] |
| Current range | Ir | [A · V⁻¹] |
| Phase difference | φ | [V] |
| Effective value | A | [V] |
| Maximum sensitivity of lock-in amplifier | F.S. | [V] |
| Sensitivity | Sen | [V] |
| Voltage amplitude | Ep-p | [Vp-p] |
| Relative dielectric constant of NMP | ∈ | [—] |
| Dielectric constant of vacuum | ∈₀ | [F · m⁻¹] |
| Ratio of the circumference of a circle to its | π | [—] |
| diameter | | |
| Transformation of effective value into wave | A′ | [—] |

(1) Amplification factor: M
Sen/F.S.
(2) Voltage transformation: Vt
M × A
(3) Current: I
Vt × Ir
(4) Current amplitude: Iₚ₋ₚ
I × A′
(5) Admittance: Y
Ip-p/Ep-p
(6) Susceptance: B
Y × Sin(φ)
(7) Angular frequency: ω
f × 2π
(8) Capacitance: C
B/ω
(9) Dielectric constant of N-methyl-2-pyrrolidone: ∈_{NMP}
32[—] × 8.85 × 10⁻¹²[F · m⁻¹] = 2.83 × 10⁻¹⁰[F · m⁻¹]
(10) Cell constant: a
∈_{NMP}/C

### [Measurement of Cell Constant]

N-Methyl-2-pyrrolidone is measured by the impedance method, and a cell constant is calculated by the above-described calculation method and defined as the cell constant. As for the condition of the aluminum foil flag type electrode, an electrode area was set to 7 mm×7 mm, and a distance between the electrodes was set to 10 mm.

### [Measurement of Admittance]

A cell whose cell constant has been measured is used, the slurry is measured by the impedance method, and an admittance is calculated by the above-described calculation method and defined as the admittance of the slurry.

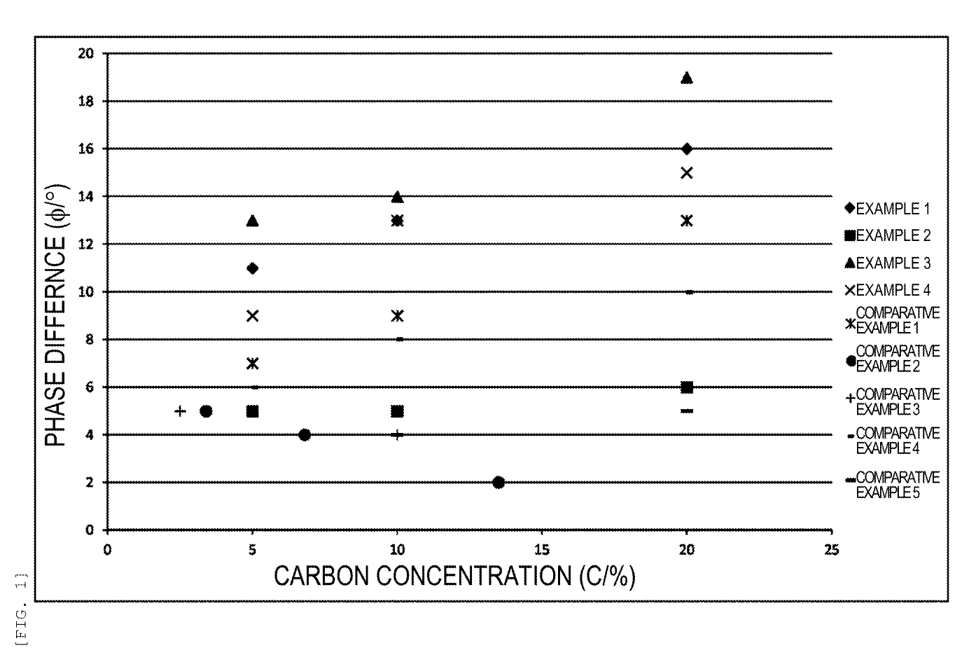

As for the condition of the alternating current impedance method, a voltage having a frequency of 1,000 Hz and an amplitude of 0.1 Vₚ₋ₚ was impressed. Results of a phase difference ϕ [°] obtained by the alternating current impedance measurement are shown in Table 3. In addition, a graph of those results is shown in FIG. 1. The abscissa expresses a solid content [%] of acetylene black in the whole slurry, and the ordinate expresses a phase difference [°].

TABLE 3

| | Carbon | |
|---|---|---|
| | concentration (%) | Phase difference (°) |
| Example 1 | 20 | 16 |
| | 10 | 13 |
| | 5 | 11 |
| Example 2 | 20 | 6 |
| | 10 | 5 |
| | 5 | 5 |
| Example 3 | 20 | 19 |
| | 10 | 14 |
| | 5 | 13 |
| Example 4 | 20 | 15 |
| | 10 | 13 |
| | 5 | 9 |
| Comparative Example 1 | 20 | 13 |
| | 10 | 9 |
| | 5 | 7 |
| Comparative Example 2 | 13.5 | 2 |
| | 6.8 | 4 |
| | 3.4 | 5 |
| Comparative Example 3 | 10 | 4 |
| | 5 | 5 |
| | 2.5 | 5 |
| Comparative Example 4 | 20 | 10 |
| | 10 | 8 |
| | 5 | 6 |
| Comparative Example 5 | 20 | 5 |
| | 10 | 4 |
| | 5 | 5 |

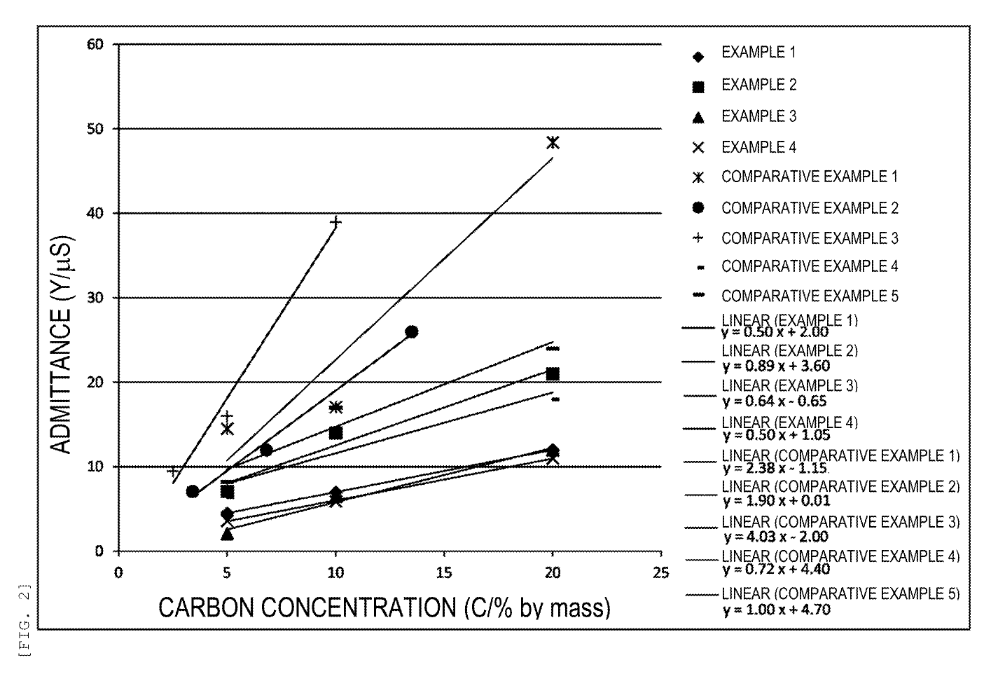

Table 4 shows the results of the admittance [μS] obtained by the alternating current impedance measurement. A graph of those results is shown in FIG. 2. The abscissa expresses a solid content [%] of acetylene black in the whole slurry, and the ordinate expresses an admittance [μS]. There was found a tendency that following a decrease of the acetylene black concentration, the admittance gradually decreases.

TABLE 4

| | | | Carbon material |
|---|---|---|---|
| | | | concentration |
| | Carbon | Admit- | dependence of |
| | concentration | tance Y | admittance |
| | (%) | (μS) | (μS/wt %) |
| Example 1 | 20.0 | 12.0 | 0.50 |
| | 10.0 | 7.0 | |
| | 5.0 | 4.5 | |
| Example 2 | 20.0 | 21.0 | 0.89 |
| | 10.0 | 14.0 | |
| | 5.0 | 7.1 | |
| Example 3 | 20.0 | 12.0 | 0.64 |
| | 10.0 | 6.5 | |
| | 5.0 | 2.1 | |
| Example 4 | 20.0 | 11.0 | 0.50 |
| | 10.0 | 5.9 | |
| | 5.0 | 3.6 | |
| Comparative Example 1 | 20.0 | 48.4 | 2.38 |
| | 10.0 | 17.1 | |
| | 5.0 | 14.5 | |
| Comparative Example 2 | 13.5 | 26.0 | 1.90 |
| | 6.8 | 12.0 | |
| | 3.4 | 7.1 | |
| Comparative Example 3 | 10.0 | 39.0 | 4.03 |
| | 5.0 | 16.0 | |
| | 2.5 | 9.5 | |
| Comparative Example 4 | 20.0 | 18.0 | 0.72 |
| | 10.0 | 14.0 | |
| | 5.0 | 6.4 | |
| Comparative Example 5 | 20.0 | 24.0 | 1.03 |
| | 10.0 | 17.0 | |
| | 5.0 | 8.0 | |

It was noted from Table 4 that the acetylene black-dispersed slurries of Examples 1 and 2 are small in the carbon material concentration dependence of admittance. In the light of the above, in the production method of a carbon material slurry capable of being used for a lithium ion secondary battery, by specifying the dispersion step such that in the resulting carbon material slurry, the carbon material concentration dependence of admittance is 1.0 μS/mass % or less, and the phase difference is 5° or more, at an impressed frequency of 1,000 Hz, performances of the resulting battery may be enhanced. In addition, for example, when applied to a lithium ion secondary battery, the discharge capacity retention rate at the time of repeated charge and discharge may be enhanced.

### INDUSTRIAL APPLICABILITY

A lithium ion secondary battery having enhanced battery performances, a carbon material-dispersed slurry suitable for the production thereof and a production method thereof, and method for controlling the quality are provided.

### REFERENCE SIGNS LIST

1: Stainless steel lead wire
2: Teflon (registered trademark) cap
3: Solderless terminal
4: Screw and nut
5: Measuring electrode
6: Tall beaker

1. A production method of an acetylene black-dispersed slurry that is a slurry containing at least acetylene black and a dispersion medium and having a content of acetylene black of 10% by mass or more and 30% by mass or less, the method comprising controlling any one of (i) a shear rate at which a viscosity becomes a minimum value, (ii) a viscosity measured by a B-type viscometer, and (iii) a concentration dependence of admittance and a phase difference obtained from an alternating current impedance measurement.

2. The production method of a slurry containing at least acetylene black and a dispersion medium according to claim 1, wherein a dispersion step is conducted until the viscosity measured by a B-type viscometer reaches 100 mPa·s or more and 5,000 mPa·s or less.

3. The production method of a slurry containing at least acetylene black and a dispersion medium according to claim 1, wherein a dispersion step is conducted until the shear rate at which the viscosity becomes a minimum value reaches 100 to 1,000 s⁻¹.

4. The production method of a slurry containing at least acetylene black and a dispersion medium according to claim 1, wherein a dispersion step is conducted until the concentration dependence of admittance reaches 1.0 μS/mass % or less, and the phase difference reaches 50 or more and 200 or less, at an impressed frequency of 1,000 Hz, as obtained by the alternating current impedance measurement.

5. A production method of a positive electrode of lithium ion secondary battery, comprising mixing a slurry obtained by the production method of a slurry according to claim 1 with at least an electrode active material and a binder to coat an electrode substrate therewith, followed by drying.

6. A lithium ion secondary battery comprising a positive electrode of lithium ion secondary battery as obtained by the production method according to claim 5.

7. A production method of a positive electrode of lithium ion secondary battery, comprising mixing a slurry obtained by the production method of a slurry according to claim 2 with at least an electrode active material and a binder to coat an electrode substrate therewith, followed by drying.

8. A lithium ion secondary battery comprising a positive electrode of lithium ion secondary battery as obtained by the production method according to claim 7.

9. A production method of a positive electrode of lithium ion secondary battery, comprising mixing a slurry obtained by the production method of a slurry according to claim 3 with at least an electrode active material and a binder to coat an electrode substrate therewith, followed by drying.

10. A lithium ion secondary battery comprising a positive electrode of lithium ion secondary battery as obtained by the production method according to claim 9.

11. A production method of a positive electrode of lithium ion secondary battery, comprising mixing a slurry obtained by the production method of a slurry according to claim 4 with at least an electrode active material and a binder to coat an electrode substrate therewith, followed by drying.

12. A lithium ion secondary battery comprising a positive electrode of lithium ion secondary battery as obtained by the production method according to claim 11.
